(19) United States
(12) Patent Application Publication
(10) Pub. No.: US 2026/0117062 A1
(43) Pub. Date: Apr. 30, 2026

(54) MINERAL-FILLED POLYCARBONATE AND/OR POLYESTER CARBONATE MOLDING COMPOUND WITH A GOOD DEGREE OF THERMAL STABILITY

(71) Applicant: COVESTRO DEUTSCHLAND AG, Leverkusen (DE)

(72) Inventors: Andreas Seidel, Dormagen (DE); Tim Hungerland, Köln (DE)

(21) Appl. No.: 19/142,664

(22) PCT Filed: Dec. 19, 2023
(86) PCT No.: PCT/EP2023/086508

§ 371 Date: Jun. 24, 2025

(30) Foreign Application Priority Data
Jan. 5, 2023 (EP) 23150469.7

(51) Int. Cl. C08L 69/00

(52) U.S. Cl. CPC C08L 69/00; C08L 2203/30; C08L 2205/025; C08L 2205/03; C08L 2205/035

(57) ABSTRACT

The invention relates to a composition containing A) at least one polycarbonate and/or polyester carbonate, B) at least one inorganic filler, C) at least one special siloxane compound, and D) at least one polymer which contains carboxy and/or dicarboxylic acid anhydride groups and structural units derived from at least one olefin, to a method for producing a molding compound from such a composition, to a molding compound obtained using such a method, to a molded body containing such a molding compound or composition, and to the use of a combination of the components C and D in order to reduce the content of free bisphenol A in molding compounds produced by means of melt compounding and/or molded bodies produced by means of a thermal shaping process, in each case containing polycarbonate and/or polyester carbonate and inorganic fillers. The polycarbonate and/or the polyester carbonate contain structural units derived from bisphenol A in each case.

The present invention relates to a mineral-filled polycarbonate and/or polyester carbonate composition, to a molding compound produced therefrom, to a process for producing a mineral-filled polycarbonate molding compound, to the use of the molding compound for production of a shaped body, to a shaped body comprising the molding compound, and to the use of a combination of an organopolysiloxane and a polymer containing carboxy groups and/or dicarboxylic anhydride groups and containing structural units derived from at least one olefin for reducing the free bisphenol A content of molding compounds produced by melt compounding and/or shaped bodies produced by thermal shaping, each comprising polycarbonate and/or polyester carbonate and inorganic filler, where the polycarbonate and/or polyester carbonate each contain structural units derived from bisphenol A.

Reinforcement of polycarbonates or polyester carbonates by addition of inorganic fillers is necessary for many applications, for example, owing to the consequently achievable increase in material stiffness, material strength and thermal conductivity and/or the improvement in dimensional stability and trueness to scale (reduction of thermal expansion and warpage).

However, it is known that the addition of inorganic fillers, especially of talc, to molten polycarbonates or polyester carbonates in melt compounding and/or in the thermal shaping of the resulting filled polymer molding compounds leads to degradation of the polymer chains. Polymer chain degradation is ultimately manifested in poorer mechanical properties of the resulting shaped bodies and, in the case of polycarbonates or polyester carbonates containing structural units derived from bisphenol A as a covalently incorporated constituent (referred to synonymously hereinafter as aromatic polycarbonate or polyester carbonate), also often in an undesirably high concentration from a regulatory point of view of free bisphenol A monomer (DPA) in the compounded material and in shaped bodies produced therefrom by thermal shaping.

In the European Union, with the aim of reducing release of BPA in the aquatic environment, there is currently discussion of a restriction under the REACH legislation for BPA in polycarbonate-containing mixtures, i.e. in compositions and molding compounds, and in polycarbonate-containing articles, i.e. in shaped bodies. There have been proposals here of limits for free BPA in mixtures and articles in the range from 10 to 150 mg/kg (ppm) as a prerequisite for future sale.

In this respect, in a first aspect of the invention, it was desirable to provide compositions suitable for production of polycarbonate or polyester molding compounds containing inorganic filler, especially containing talc, and having improved thermal stability in relation to unwanted degradation of the polymer chains in production of molding compounds by melt compounding and in further verbal shaping of the molding compounds obtained in this way. Such degradation of the polymer chains may be manifested, for example, in a drop in average molecular weight, a drop in viscosity or an increase in free monomer units, i.e. those not bonded to the polymer chain.

In a second aspect of the invention, it was desirable in particular to provide compositions suitable for production of polycarbonate or polyester carbonate molding compounds and of shaped bodies produced by thermal shaping thereof and containing inorganic filler, especially talc, where the polycarbonate or polyester carbonate contains structures derived from bisphenol A and where the molding compounds and/or the shaped bodies have a reduced bisphenol A content. In such molding compounds, a rise in free bisphenol A under thermal stress in the course of production and/or shaping thereof is an indication of unwanted degradation of polymer chains.

A known starting point for improvement of thermal stability of polycarbonate and polyester carbonate compositions containing inorganic fillers, especially also talc, in the melt is the addition of Brønsted acids, which results in neutralization of basic groups at the surface of the inorganic filler that are responsible for ester cleavage in the polycarbonate.

US 2006/0287422 A1 discloses thermoplastic compositions containing a mineral filler and a preferably inorganic acid or an acidic salt of a preferably inorganic acid, where acid or acidic salt and filler are used in the composition in a weight ratio of at least 0.0035:1. Molding compounds consisting of such compositions have improved mechanical properties and improved thermal stability of the polycarbonate toward molecular weight degradation.

WO 2013/060687 A1 discloses polycarbonate compositions stabilized with a Brønsted-acidic compound and having improved thermal processing stability, which are produced in a specific process in which the Brønsted-acidic compound is taken up on an inorganic or organic adsorber/absorber, preferably on a finely divided silica, prior to compounding.

A known starting point for improvement of thermal stability of polycarbonate and polyester carbonate compositions containing inorganic fillers in the melt is sizing of the filler, which results in chemical masking of basic groups at the surface of the inorganic filler that are responsible for ester cleavage in the polycarbonate, hence allowing a reduction in degradation of the polymer chains.

EP 3250639 B1 discloses reinforced resin compositions having improved thermal stability, comprising 75% to 99% by weight of polycarbonate, a functionalizing agent and an inorganic filler functionalized with the functionalizing agent, where the functionalized inorganic filler is used in an amount of 1% to 25% by weight and where the functionalizing agent comprises at least one organomodified silane selected from a methacrylate silane (MEMO silane), a vinyl silane, a phenyl silane, an epoxy silane and combinations thereof. However, silanes are components that are likely to be unwanted in terms of their volatility, possible toxicological effects and physical hazard features. Furthermore, this application also discloses, as a comparative example, a polycarbonate resin composition comprising talc that has been surface-functionalized with 0.5% by weight of an organomodified alkylsiloxane.

EP 3504272 B1 discloses compositions for producing shaped articles having improved multiaxial impact resistance, obtained by mixing A) polycarbonate. B) unsized talc and C) at least one anhydride-modified alpha-olefin polymer having an acid number of at least 30 mg KOH/g and an average molecular weight M_{w} of 4000 to 40 000 g/mol, where the amounts of B) and C) prior to mixing are matched to one another such that 0.10 to 1.4 parts by weight of component C) are used per 10 parts by weight of component B). This application also discloses the use of the anhydrite-modified alpha-olefin polymer having the aforementioned features for thermal stabilization of polycarbonate in a melt composition containing unsized talc, where talc and anhydride-modified alpha-olefin polymer are used in the aforementioned ratio of parts by weight.

None of the above-cited prior art documents discloses the extent to which the measures for thermal stabilization of the polycarbonate affect the free bisphenol A monomer content in mineral-filled polycarbonate or polyester car compositions obtained by melt compounding (also referred to as compound or molding compound) and of shaped bodies obtained therefrom by thermal shaping. In principle, thermal instability of the polycarbonate or polyester carbonate caused by the presence of inorganic fillers, which is manifested in chain cleavage of the polymer, need not necessarily also lead to a significant rise in the content of free bisphenol A monomer, since the hydrolysis of the polycarbonate and polyester carbonate which is responsible for chain degradation can in principle take place randomly at any carbonate group in the polymer chain by virtue of the residual moisture which is unavoidable in the course of compounding or further thermal shaping, and hence attack at the chain end that would lead to release of free bisphenol A monomer is at first relatively unlikely. This means that there can be a considerable decrease in polymer molecular weight, resulting in a considerable increase in melt flowability (measured, for example, by a melt flow index MFR), before a significant increase in the free bisphenol A content in the compound or in the molded articles produced therefrom is recorded to a notable degree.

It has been found that, surprisingly, a composition comprising
A) at least one polycarbonate and/or polyester carbonate,
B) at least one inorganic filler,
C) at least one compound or a mixture of two or more different compounds of the general structural formula [V]

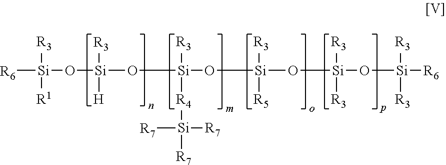

in which
R₃ represents identical or different radicals selected from the group consisting of linear or branched alkyl, aryl, alkylaryl or arylalkyl radicals having 1 to 25 carbon atoms and haloalkyl, haloaryl, haloalkylaryl or haloarylalkyl radicals having 1 to 25 carbon atoms,
R₄ represents identical or different alkylene radicals which have 1 to 20 carbon atoms and may optionally contain ether, ester, urethane or amide groups,
R₅ represents identical or different oxyalkylene radicals of the general formula [Va]

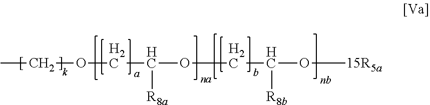

where, in formula [Va],
R₅ₐ, R₈ₐ and R_{8b} independently represent identical or different, optionally branched alkyl or aryl radicals optionally bearing heteroatom substituents, or hydrogen,
k is an integer from 2 to 11,
   a, b are identical or different integers between 1 and 4 and
   na and nb are identical or different integers between 0 and 50,
   where k, na and nb each indicate the number of structural units shown in the respective set of brackets in the oxyalkylene radical of the general formula [Va] and where these structural units shown in the brackets may be present either in blocks or in random arrangement in the oxyalkylene radicals of the general formula [Va],
   R₆ represents identical or different radicals selected from the group consisting of R₃, —R₄Si(R₇)₃. R₅ and H.
   R₇ represents identical or different alkyl, alkoxy, aryl or aryloxy radicals having 1 to 20 carbon atoms, with the proviso that at least one instance of R₇ is a C1- to C5-alkoxy group, and
   n is an integer from 0 to 20,
   m is an integer from 0 to 20.
   is an integer from 0 to 20 and
   p is an integer from 1 to 200.
   where n, m, o and p each indicate the number of structural units shown in the respective set of brackets in the organopolysiloxane and where these structural units shown in the brackets may be present either in blocks or in random arrangement in the organopolysiloxane.
   where either m and/or o≥1, and/or at least one R₃ radical in the compound of formula [V] is a linear or branched alkyl, aryl, alkylaryl or arylalkyl radical having 5 to 25 carbon atoms and where the value of the sum total of n+m+o+p is >5.
D) at least one polymer containing carboxy and/or dicarboxylic anhydride groups and containing structural units derived from at least one olefin.
satisfies the abovementioned first aspect of the invention.

It has also been found that, surprisingly, a composition as described above, where component A contains structural units derived from bisphenol A, satisfies the abovementioned second aspect of the invention.

Component C is preferably used in the compositions of the invention in an amount of 0.2 to 5 parts by weight, further preferably 0.5 to 2 parts by weight, more preferably 0.7 to 1.5 parts by weight, based on a total of 100 parts by weight of components B and C.

Component D is preferably used in the compositions of the invention in an amount of 1 to 15 parts by weight, more preferably 2 to 10 parts by weight, more preferably 3 to 7 parts by weight, based on a total of 100 parts by weight of components B and D.

The composition preferably contains
25% to 95% by weight, further preferably 30% to 85% by weight, more preferably 40% to 75% by weight, of component A.
1% to 50% by weight, further preferably 3% to 40% by weight, more preferably 5% to 30% by weight, of component B.
0.002% to 2.5% by weight, further preferably 0.015% to 0.8% by weight, more preferably 0.035% to 0.45% by weight, of component C.
and 0.01% to 7.5% by weight, further preferably 0.06 to 4.0, more preferably 0.15% to 2.1% by weight, of component D.

The stated percentages by weight are based on the overall composition.

In a preferred embodiment, component C is at least partly in the form of sizing on the surface of component B (also referred to synonymously hereinafter as surface treatment). The expression “sizing” in the context of the invention means that component C is in contact with the surface of component B. Component C may be chemically bound to component B or be in contact with the surface of component B via purely physical interactions. A portion of the fraction of component C present as sizing on the surface of component B may also be chemically attached to component B, and a further portion in contact with the surface of component B via purely physical interactions.

It is thus also possible that component C is used in the composition partly or wholly as a constituent of at least one sized inorganic filler, where the sizing material contains an organopolysiloxane of component C or consists of an organopolysiloxane of component C. In this case, at least a portion of each of components B and C is thus used as a constituent of the compositions of the invention in the form of a preparation comprising components B and C. In this case, the abovementioned proportions of components B and C relate to the sum total of the proportions of the respective components that are used in the compositions of the invention in the form of one or more formulations composed of components B and C and optionally as amounts of components B and/or C that are additionally used separately.

Components E that are present in the composition may be one or more polymer additives and/or process auxiliaries and/or further polymeric components, preferably in an amount of 0.01% to 70% by weight, further preferably 0.05% to 50% by weight, more preferably 0.1% to 40% by weight.

In a specific embodiment, the composition contains further polymeric components of component E in an amount of not more than 2% by weight. In this case, component E is used in a total amount of preferably 0.01% to 5% by weight, further preferably 0.05% to 3% by weight, more preferably 0.1% to 2% by weight.

In a preferred embodiment the composition consists, to an extent of 90% by weight, further preferably to an extent of 95% by weight, and most preferably solely, of components A, B, C, D and E.

### Component A

Polycarbonates and/or polyester carbonates of component A that are suitable in accordance with the invention are known from the literature or can be produced by processes known from the literature (for production of polycarbonates see for example Schnell. “Chemistry and Physics of Polycarbonates”. Interscience Publishers. 1964 and DE-B 1 495 626. DE-A 2 232 877. DE-A 2 703 376. DE-A 2 714 544, DE-A 3 000 610, DE-A 3 832 396; for production of polyester carbonates, for example DE-A 3 007 934).

Polycarbonates that are suitable in accordance with the invention as component A are produced, for example, by reaction of at least one aliphatic or aromatic diol, preferably of bisphenol A and optionally further diphenols and/or aliphatic diols, further preferably of bisphenol A and optionally further diphenols, more preferably of bisphenol A, with carbonyl halides, preferably phosgene, and/or with aromatic dicarbonyl dihalides, preferably benzenedicarbonyl halides, by the interfacial process, optionally using chain terminators, for example monophenols, and optionally using trifunctional or more than trifunctional branching agents, for example triphenols or tetraphenols.

Likewise possible is production via a melt polymerization process by reaction of aforementioned diols and diol mixtures with, for example, diphenyl carbonate.

Diphenols other than bisphenol A which are suitable for producing the polycarbonates suitable in accordance with the invention as component A and/or for producing the polyester carbonates suitable in accordance with the invention as component A preferably include those of the formula (I)

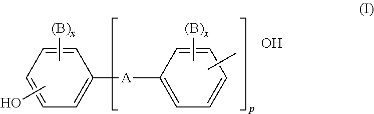

where
A is a single bond, C₁- to C₅-alkylene, C₂- to C₅-alkylidene, C₅- to C₆-cycloalkylidene, —O—, —SO—, —CO—, —S—, —SO₂—, C₆- to C₁₂-arylene, onto which further aromatic rings optionally containing heteroatoms may be fused,
   or a radical of the formula (II) or (III)

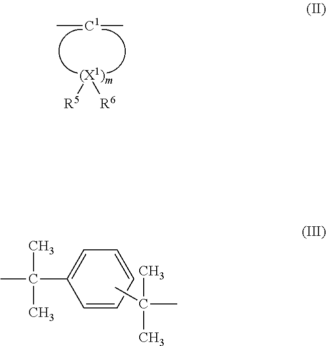

B is in each case C₁ to C₁₂ alkyl, preferably methyl, halogen, preferably chlorine and/or bromine,
X is in each case independently 0, 1 or 2,
p is 1 or 0, and
R⁵ and R⁶ are individually selectable for each X¹ and are independently hydrogen or C₁ to C₆ alkyl, preferably hydrogen, methyl or ethyl,
X¹ is carbon and m is an integer from 4 to 7, preferably 4 or 5, with the proviso that, on at least one atom X¹, R⁵ and R⁶ are both alkyl.

Preferred diphenols used alongside bisphenol A are hydroquinone, resorcinol, dihydroxydiphenols, bis(hydroxyphenyl) C₁-C₅ alkanes, bis(hydroxyphenyl) C₅-C₆ cycloalkanes, bis(hydroxyphenyl) ethers, bis(hydroxyphenyl) sulfoxides, bis(hydroxyphenyl) ketones, bis(hydroxyphenyl) sulfones and α,α-bis(hydroxyphenyl)diisopropylbenzenes and also ring-brominated and/or ring-chlorinated derivatives thereof.

Particularly preferred further diphenols are 4,4-dihydroxy biphenyl, 2,4-bis(4-hydroxyphenyl)-2-methylbutane, 1,1-bis(4-hydroxyphenyl)cyclohexane, 1,1-bis(4-hydroxyphenyl)-3,3,5-trimethylcyclohexane, 4,4′-dihydroxy diphenyl sulfide, 4,4-dihydroxydiphenyl sulfone, and also the di- and tetrabrominated or chlorinated derivatives thereof, for example 2,2-bis(3-chloro-4-hydroxyphenyl)propane, 2,2-bis(3,5-dichloro-4-hydroxyphenyl)propane or 2,2-bis(3,5-dibromo-4-hydroxyphenyl)propane.

These diphenols may be used individually or in the form of any desired mixtures. The diphenols are known from the literature or obtainable by processes known from the literature.

Polycarbonates used in accordance with the invention preferably contain at least 20% by weight, further preferably at least 50% by weight, more preferably at least 80% by weight, most preferably 100% by weight, based in each case on the sum of all structural units derived from bisphenols, of such structural units derived from bisphenol A.

Suitable aliphatic diols are selected from the group consisting of cyclohexane-1,2-diol, cyclohexane-1,3-diol, cyclohexane-1,4-diol, cyclohexane-1,2-dimethanol, cyclohexane-1,3-dimethanol, cyclohexane-1,4-dimethanol, 2,2-bis(4-hydroxycyclohexyl)propane, tetrahydrofuran-2,5-dimethanol, 2-butyl-2-ethylpropane-1,3-diol, 2-(2-hydroxyethoxy)ethanol, 2,2,4,4-tetramethylcyclobutane-1,3-diol, 2,2,4-trimethylpentane-1,3-diol, 2,2-dimethylpropane-1,3-diol, cyclobutane-1,1-diyldimethanol, 8-(hydroxymethyl)-3-tricyclo[5.2.1.0^{2,6}]decanyl]methanol, propane-1,2-diol, propane-1,3-diol, butane-1,4-diol, pentane-1,5-diol, hexane-1,6-diol, octane-1,8-diol, isosorbide and any desired mixtures thereof.

Examples of chain terminators suitable for the production of the polycarbonates include phenol, p-chlorophenol, p-tert-butylphenol or 2,4,6-tribromophenol, and also long-chain alkylphenols such as 4-[2-(2,4,4-trimethylpentyl)]phenol, 4-(1,3-tetramethylbutyl)phenol according to DE-A 2 842 005 and monoalkylphenol or dialkylphenols having a total of from 8 to 20 carbon atoms in the alkyl substituents, for example 3,5-di-tert-butylphenol, p-isooctylphenol, p-tert-octylphenol, p-dodecylphenol and 2-(3,5-dimethylheptyl)phenol and 4-(3,5-dimethylheptyl)phenol. The amount of chain terminators to be used is generally between 0.5 mol % and 10 mol % based on the molar sum of the diphenols used in each case.

The thermoplastic aromatic polycarbonates have average molecular weights (weight-average M_{w}) of preferably 17 000 to 40 000 g/mol, further preferably 20 000 to 35 000 g/mol, more preferably 24 000 to 32 000 g/mol, measured by GPC (gel permeation chromatography) using dichloromethane as solvent, calibration with linear polycarbonates (consisting of bisphenol A and phosgene) of known molar mass distribution from PSS Polymer Standards Service GmbH. Germany, and calibration according to method 2301-0257502-09D (2009 edition in German language) from Currenta GmbH & Co. OHG, Leverkusen. The eluent is dichloromethane. Column combination of crosslinked styrene-divinylbenzene resins. Diameter of the analytical columns: 7.5 mm; length: 300 mm. Particle sizes of the column material: 3 μm to 20 μm. Concentration of the solutions: 0.2% by weight. Flow rate: 1.0 ml/min, temperature of the solutions: 30° C. Use of UV and/or RI detection. The preferred molecular weight ranges result in a particularly advantageous balance of mechanical and rheological properties in the compositions of the invention.

The polycarbonates may be branched in a known manner, preferably via incorporation of 0.05 to 2.0 mol %, based on the sum of the diphenols used, of trifunctional or more than trifunctional compounds, for example those having three or more phenolic groups. Preference is given to using linear polycarbonates, further preferably those based on bisphenol A.

Both homopolycarbonates and copolycarbonates are suitable. Inventive copolycarbonates of component A may also be produced using 1% to 25% by weight, preferably 2.5% to 25% by weight, based on the total amount of diphenols to be used, of polydiorganosiloxanes having hydroxyaryloxy end groups. These are known (U.S. Pat. No. 3,419,634) and producible by processes known from the literature. The production of polydiorganosiloxane-containing copolycarbonates is described for example in DE-A 3 334 782 and WO 2015/052106 A2.

Preference is also given to copolycarbonates produced using diphenols of the following structures:

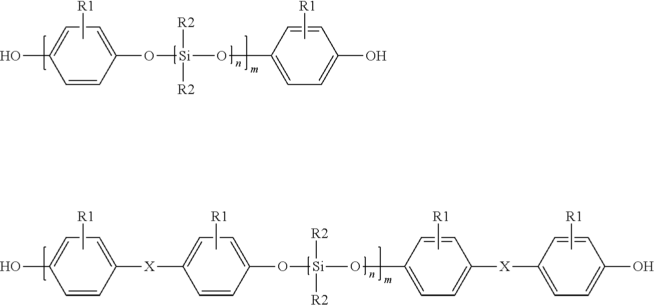

where R1 is hydrogen. C₁ to C₄ alkyl, preferably hydrogen or methyl, and especially preferably hydrogen,
R2 is independently aryl or alkyl, preferably methyl,
X is a single bond, —SO₂—, —CO—, —O—, —S—, C₁ to C₆ alkylene, C₂ to C₈ alkylidene or C₆ to C₁₂ arylene, which may optionally be fused with further aromatic rings containing heteroatoms,
X is preferably a single bond, C₁ to C₈ alkylene, C₂ to C₈ alkylidene, C₅ to C₁₂ cycloalkylidene, —O—, —SO—, —CO—, —S—, —SO₂—, more preferably X is a single bond, isopropylidene, C₅ to C₁₂ cycloalkylidene or oxygen, and very more preferably is isopropylidene,
n is an average number from 10 to 400, preferably 10 to 100, especially preferably 15 to 50, and
m is an average number from 1 to 10, preferably from 1 to 6 and especially preferably from 1.5 to 5.

Aromatic dicarbonyl halides for production of polyester carbonates are preferably the diacyl chlorides of isophthalic acid, terephthalic acid, diphenyl ether 4,4′-dicarboxylic acid and naphthalene-2,6-dicarboxylic acid. Particular preference is given to mixtures of the diacyl chlorides of isophthalic acid and terephthalic acid in a ratio of between 1:20 and 20:1.

In the production of polyester carbonates, a carbonyl halide, preferably phosgene, is additionally used as a bifunctional acid derivative.

In addition to the aforementioned monophenols, useful chain terminators for production of the polyester carbonates also include the chlorocarbonic esters thereof and the acyl chlorides of aromatic monocarboxylic acids, which may optionally be substituted by C₁ to C₂₂ alkyl groups or by halogen atoms, and aliphatic C₂ to C₂₂ monocarbonyl chlorides.

The amount of chain terminators is in each case 0.1 to 10 mol %, based on moles of diphenol in the case of the phenolic chain terminators and on moles of dicarbonyl dichloride in the case of monocarbonyl chloride chain terminators.

In the production of polyester carbonates, it is additionally possible to use one or more aromatic hydroxycarboxylic acids.

The polyester carbonates may be either linear or else branched in known fashion (see DE-A 2 940 024 and DE-A 3 007 934), wherein linear polyester carbonates are preferred.

Branching agents used may be, for example, tri- or polyfunctional carbonyl chlorides, such as trimesyltrichloride, cyanuric trichloride, 3,3,4,4′-benzophenonetetracarbonyl chloride, 1,4,5,8-naphthalenetetracarbonyl chloride or pyromellitic tetrachloride, in amounts of 0.01 to 1.0 mol % (based on dicarbonyl chlorides used), or tri- or polyfunctional phenols, such as phloroglucinol, 4,6-dimethyl-2,4,6-tri(4-hydroxyphenyl)hept-2-ene, 4,6-dimethyl-2,4,6-tri(4-hydroxyphenyl)heptane, 1,3,5-tri(4-hydroxyphenyl)benzene, 1,1,1-tri(4-hydroxyphenyl)ethane, tri(4-hydroxyphenyl)phenyl-methane, 2,2-bis[4,4-bis(4-hydroxyphenyl)cyclohexyl]propane, 2,4-bis(4-hydroxyphenyl-isopropyl)phenol, tetra(4-hydroxyphenyl)methane, 2,6-bis(2-hydroxy-5-methylbenzyl)-4-methylphenol, 2-(4-hydroxyphenyl)-2-(2,4-dihydroxyphenyl)propane, tetra(4-[4-hydroxyphenylisopropyl]phenoxy)methane, 1,4-bis[4,4-dihydroxytriphenyl)methyl]benzene, in amounts of 0.01 to 1.0 mol % based on diphenols used. Phenolic branching agents may be included in the initial charge with the diphenols; acid chloride branching agents may be introduced together with the acid chlorides.

The proportion of carbonate structural units in the polyester carbonates may be varied as desired. The proportion of carbonate groups is preferably up to 90 mol %, especially up to 80 mol %, more preferably up to 50 mol %, based on the sum of ester groups and carbonate groups. Both the ester fraction and the carbonate fraction of the polyester carbonates may be present in the form of blocks or have a random distribution in the polycondensate.

The polycarbonates and polyester carbonates may be used alone or in any desired mixture.

Preference is given to using linear polycarbonate based on exclusively bisphenol A as component A.

### Component B

The composition comprises at least one inorganic filler as component B. The expression “inorganic filler” in the context of the present invention means any kind of inorganic material, irrespective of the chemical nature or origin thereof, for example with regard to natural or synthetic origin, particle size and particle geometry, and especially also irrespective of the function thereof in the composition of the invention. “Inorganic fillers” of component B thus does not mean exclusively those inorganic materials that serve for filling of the polymer for the purpose of cost dilution. Instead, the term “inorganic filler” especially also includes inorganic functional fillers that are used as functional additive, for example reinforcers, pigments, flame retardants, etc.

Component B which is used in the compositions of the invention is preferably at least one inorganic filler selected from the group consisting of quartz compounds, talc, wollastonite, kaolin. CaCO₃, titanium dioxide and other inorganic pigments. Al(OH)₃, AlO(OH), Mg(OH)₂, micas and glass fibers. Preferred compositions contain talc as a constituent of component B. In particularly preferred compositions, exclusively talc is used as component B, alongside inorganic pigments that are optionally used for coloring.

The inorganic fillers of component B may have been fully or partly surface-modified with a size other than component C which contains at least one or a combination of two or more organic substances that may be partly chemically bound to the inorganic filler (for example when it functions as an adhesion promoter), and may partly be in free form, i.e. physically wet the inorganic filler in unbound form. The unbound size content, i.e. the content not chemically attached to the inorganic filler, can be separated by means of extraction, for example, preferably in dichloromethane, and analyzed.

Suitable glass fibers of component B are preferably produced from E. A or C glass. The average diameter of the glass fiber is preferably from 5 to 25 μm, more preferably from 6 to 20 μm, most preferably from 7 to 15 μm. Chopped glass fibers have an average length of preferably 1 to 10 mm, preferably 2.0 to 7.5 mm, especially preferably 2.5 to 5.0 mm.

Particular preference is given to using glass fibers having an aspect ratio, i.e. a quotient of the average fiber length to average fiber diameter, of at least 100, more preferably at least 200, especially preferably at least 300.

The aforementioned geometric features of the glass fibres (length, diameter and aspect ratio) are ascertained on component B used (i.e. prior to production of the composition of the invention and in particular prior to production of the thermoplastic molding compounds of the invention and of shaped bodies of the invention obtained therefrom by thermal shaping). In the course of production of the compositions, molding compounds and shaped bodies by physical mixing processes, compounding or thermal shaping, it is naturally not possible to rule out any reduction in said ratio aspect as a result of shearing for example, and so the glass fibers in the compositions, molding compounds and shaped bodies of the invention will generally have a lower aspect ratio than originally ascertained on the component B used.

Suitable quartz compounds are, for example with preference, those consisting to an extent of more than 97% by weight of silicon dioxide (quartz). Their particle shape is spherical and/or approximately spherical.

Preferred quartz compounds are finely divided (amorphous) fused ground quartzes produced from electrically molten silicon dioxide by iron-free grinding with subsequent air classification. It is likewise possible to use ground quartzes produced from treated quartz sand.

Commercially available fused ground quartzes include for example Amosil™ FW600 or Amosil™ FW600 from Quarzwerke GmbH (Germany). Commercially available ground quartzes include for example Sikron™ SF300, Sikron™ SF600, Sikron™ SF800, Silbond™ SF600 EST from Quarzwerke GmbH (Germany) or Mikro-Dorsilit™ 120 from QUARZSANDE GmbH (Austria).

Useful talc in the context of the invention is any talc-based filler that the person skilled in the art associates with talc or talcum. In particular, useful fillers are all of those that are commercially available and include the words talc or talcum as characterizing features in their product descriptions. It is also possible to use mixtures of various mineral fillers based on talc.

Preference is given in accordance with the invention to mineral fillers having a talc content according to DIN 55920 (2006 version) of greater than 80% by weight, preferably greater than 95% by weight and more preferably greater than 98% by weight based on the total mass of the filler. Talc means a naturally occurring or synthetically produced talc.

Pure talc has the chemical composition 3MgO·4SiO₂·H₂O and hence has an MgO content of 31.9% by weight, an SiO₂ content of 63.4% by weight and a chemically bound water content of 4.8% by weight. It is a silicate having a layered structure.

Naturally occurring talc materials generally do not have the above-recited ideal composition since they are contaminated via partial replacement of the magnesium by other elements, via partial replacement of silicon by aluminum for example and/or via intergrowth with other minerals, for example dolomite, magnesite and chlorite.

The talc types used as component B preferably feature a particularly high purity, characterized by an MgO content of 28% to 35% by weight, preferably 30% to 33% by weight, more preferably 30.5% to 32% by weight, and an SiO₂ content of 55% to 65% by weight, preferably 58% to 64% by weight, more preferably 60% to 62.5% by weight. The particularly preferred talc grades also feature an Al₂O₃ content of less than 5% by weight, more preferably less than 1% by weight, especially less than 0.7% by weight.

It is advantageous and hence preferred in particular to use of the tale of the invention in the form of finely ground grades having a median particle size d₅₀ of ≤10 μm, preferably ≤5 μm, further preferably ≤4 μm and more preferably ≤3 μm. Greater median particle sizes have an adverse effect on the mechanical properties of the molding compounds of the invention and molded articles produced therefrom.

It is advantageous and preferred also to use the talc with a median particle size d₅₀ of ≥0.2 μm, preferably >0.5 μm, further preferably >1 μm and more preferably ≥2 μm. Smaller median particle sizes have an adverse effect on the free bisphenol A content in the molding compounds of the invention and molded articles produced therefrom.

In this respect, it is particularly advantageous to use talc having a median particle size d₅₀ of 0.2 to 10 μm, preferably 0.5 to 5 μm, further preferably 1 to 4 μm and more preferably 2 to 3 μm.

Talc of these geometric particle dimensions can be produced, for example and with preference, by wet grinding with addition of, for example and with preference, water.

The median particle size d₅₀ is the diameter, measured by sedimentation analysis to ISO 13317-3 (2001-03 version), above and below which 50% each by weight of the particles are found. It is also possible to use mixtures of talc grades which differ in their d₅₀ median particle size.

The talc grades to be used in accordance with the invention preferably have an upper particle or grain size d₉₅, likewise measured by sedimentation analysis to ISO 13317-3 (2001-03 version), of below 30 μm, preferably below 20 μm, more preferably below 10 μm and especially preferably below 8 μm.

With regard to processing and production of the molding compounds, it is also advantageous to use a compacted talc. Compacted talc can be produced, for example with preference, by blending of the ground talc with water and optionally further processing auxiliaries, followed by pressing under elevated pressure.

As a result of the processing to give the molding compound/shaped bodies, the talc used may have a smaller d₉₇/d₅₀ in the molding compound/shaped body than in the originally used form.

Component B used may also be kaolin, preferably a calcined kaolin.

The primary constituent of the naturally occurring kaolin is kaolinite, Al₂(OH)₄[Si₂O₅]; secondary constituents are feldspars, mica and quartz. In addition to this composition, it is also possible to use kaolins which, instead of or in addition to kaolinite, also contain nacrite, dickite, halloysite and hydrated halloysite.

The calcined kaolin according to the invention is obtained by heat treatment of a kaolin at at least 500° C., preferably from 850° C., to 1100° C. The hydroxyl groups, which form part of the crystal structure of kaolin, are lost during this heat treatment and the kaolin is converted into calcined kaolin.

In addition, the inorganic filler used may, according to the invention, also be wollastonites that optionally have organic surface modification. Wollastonites having organic surface modification preferably have a carbon content based on the wollastonite of greater than 0.1% by weight, preferably 0.2% to 2% by weight, more preferably 0.3% to 1% by weight, very more preferably 0.3% to 0.6% by weight, determined by elemental analysis. Such wollastonites are commercially available, for example under the trade name Nyglos™ from NYCO Minerals Inc. Willsboro, NY. USA and the type designations Nyglos™ 4 or Nyglos™ 5, or—in the case of surface—modified wollastonites-under the type designations Nyglos™ 4-10992 or Nyglos™ 5-10992.

Preferred wollastonites have an average aspect ratio, i.e. a ratio of the average length of the fiber to the average diameter, of >6, in particular ≥7, and an average fiber diameter of 1 to 15 μm, preferably 2 to 10 μm, in particular from 4 to 8 μm.

A further suitable inorganic filler is calcium carbonate. CaCO₃. Calcium carbonate occurs naturally in the form of minerals such as calcite, aragonite and vaterite, as well as being the primary constituent of limestone, chalk and marble. Calcium carbonate may also be produced by synthesis, which can be advantageous on account of the higher purity. Preference is given to using calcium carbonate having a median particle diameter d₅₀ of 0.1 to 5 μm.

Another suitable inorganic filler is aluminum hydroxide, Al(OH)₃. Aluminum hydroxide occurs naturally in the form of minerals such as gibbsite, bayerite and nordstrandite. Aluminum hydroxide may also be produced by synthetic means which can be beneficial on account of the higher purity. Preference is given to using calcium carbonate having a median particle diameter d₅₀ of 1 to 5 μm.

Another suitable inorganic filler is mica or metal oxide-coated mica. The mica may be naturally occurring or synthetically produced mica, the latter being preferable owing to its typically higher purity. Mica which is obtained from nature is typically accompanied by further minerals. “Mica” in the case of natural inorganic filler also comprises corresponding impurities in the amount specified. The mica is preferably muscovite-based, i.e. it preferably comprises at least 60% by weight, more preferably at least 70% by weight, yet more preferably at least 85% by weight, especially preferably at least 90% by weight, of muscovite, based on the total weight of the mica content.

In the case of metal oxide-coated micas, the metal oxide coating preferably comprises one or more coating layers containing titanium dioxide, tin oxide, aluminum oxide and/or iron oxide, where the metal oxide is further preferably iron (III) oxide (Fe2O3), iron (II, III) oxide (Fe3O4, a mixture of Fe2O3 and FeO) and/or titanium dioxide, more preferably titanium dioxide. Such metal oxide-coated micas are generally used as effect pigment.

The median particle size (d₅₀) of the optionally metal oxide-coated mica, determined by laser diffractometry on an aqueous slurry of the pigment, is preferably 1 to 100 μm, further preferably 5 to 80 μm for synthetic mica and further preferably 3 to 30 μm for natural mica, generally for mica more preferably 3.5 to 15 μm, even more preferably 4.0 to 10 μm, most preferably 4.5 to 8.0 μm. Commercially available suitable micas include for example products of the product group Tremica™ from HPF Minerals (Quarzwerke Gruppe, Germany).

It is preferably also possible to use, as component B or as part of component B, one or more pigments based on titanium dioxide, iron oxide, aquamarine, ultramarine blue, zinc white and zinc oxide as inorganic fillers.

These are naturally occurring, synthetically produced or modified naturally occurring pigments or mixtures thereof. The titanium dioxide pigments preferably have a crystal structure modification selected from rutile, anatase or brookite. The preferred modification is rutile.

Pigments of the invention based on titanium dioxide have a density (according to DIN EN ISO 787-10) of 3.6 to 4.4 g/cm³, preferably of 3.8 to 4.3 g/cm³, more preferably of 4.0 to 4.2 g/cm³.

The pigments based on titanium dioxide may be obtained in a known manner by the sulfate process or the chloride process from natural raw materials such as ilmenite, rutile ore or TiO₂ slag.

The pigments may have inorganic surface modification, preferably based on aluminum compounds. The proportion of titanium dioxide (according to DIN EN ISO 591) is preferably >90% by weight, more preferably >92% by weight, further preferably >95% by weight.

In preferred embodiments, the pigments have an oil absorption (according to ISO787-5) of 5 to 50 g/100 g of pigment, further preferably of 10 to 25 g/100 g of pigment and more preferably of 12 to 18 g/100 g of pigment.

### Component C

Inventive component C is an organopolysiloxane containing at least one structural unit of the general formula (IV):

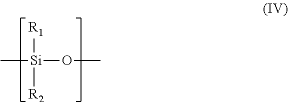

in which R¹ and R² are independently hydrogen or hydrocarbyl radicals that may each be substituted or unsubstituted and optionally interrupted by heteroatoms such as O, N or Si, and may be linear, branched or cyclic,
where the organopolysiloxane contains at least one structural unit of the general formula (IV) in which at least one of the R₁ or R₂ radicals is different than both hydrogen and methyl, and
where the organopolysiloxane is free of siloxane structural units in which two hydrogen atoms are bonded to the same silicon atom.

Preferred hydrocarbyl radicals R₁ and R₂ are, for example, alkyl, aryl, alkylaryl, arylalkyl or cycloalkyl groups, each of which may be substituted or unsubstituted and optionally be interrupted by heteroatoms. The R₁ and R₂ radicals are preferably hydrocarbyl radicals having 1 to 25 carbon atoms.

Examples of hydrocarbyl R₁ and R₂ are methyl, ethyl, n-propyl, isopropyl, n-butyl, isobutyl, tert-butyl, n-pentyl, isopentyl, neopentyl, tert-pentyl radical, hexyl radicals, heptyl radicals, octyl radicals, nonyl radicals, decyl radicals, dodecyl radicals, octadecyl radicals, cycloalkyl radicals, for example cyclopentyl, cyclohexyl, cycloheptyl radicals and methylcyclohexyl radicals; aryl radicals, for example phenyl, biphenyl, naphthyl and anthryl and phenanthryl radical; alkaryl radicals, for example o-, m-, p-tolyl radicals, xylyl radicals and ethylphenyl radicals; aralkyl radicals, for example the benzyl radical, the α- and the β-phenylethyl radical.

In a likewise preferred embodiment, the organopolysiloxane has the structure of formula (V):

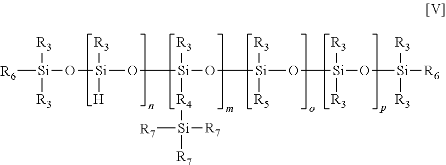

in which
R₃ represents identical or different radicals selected from the group of the linear or branched alkyl, aryl, alkylaryl or arylalkyl radicals having 1 to 25 carbon atoms, especially 1 to 20 carbon atoms, or haloalkyl groups having 1 to 25 carbon atoms, especially 1 to 20 carbon atoms, where preferably at least 50 mol %, further preferably at least 70 mol %, most preferably at least 80 mol %, of the R₃ radicals are methyl groups,
R₄ represents identical or different alkylene radicals having 1 to 20 carbon atoms, preferably having 1 to 10 carbon atoms, especially having 2 to 5 carbon atoms, which may optionally contain ether, ester, urethane or amide groups, more preferably ethylene radicals,
R₅ represents identical or different oxyalkylene radicals of the formula (Va)

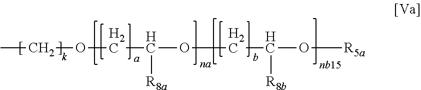

where
R₅ₐ, R₈ₐ and R_{8b} represent identical or different, optionally branched alkyl or aryl radicals optionally bearing heteroatom substituents, or hydrogen, preferably hydrogen, methyl radicals and/or ethyl radicals, and 20
k is an integer from 2 to 11,
a, b are identical or different integers between 1 and 4 and
na and nb are identical or different integers from 0 to 50, with preferably 1<na+nb≤50, further preferably with 1<na+nb≤30, especially 1<na+nb≤15,
where k, na and nb each indicate the number of structural units shown in the respective set of brackets in the oxyalkylene radical of the general formula [Va] and where these structural units shown in the brackets may be present either in blocks or in random arrangement in the oxyalkylene radicals of the general formula [Va].
R₆ represents identical or different radicals selected from the group consisting of R₃, —R₄—Si(R₇)₃, R₅ and H,
R₇ represents identical or different alkyl, alkoxy, aryl or aryloxy radicals having 1 to 20 carbon atoms, with the proviso that at least one instance of R₇ is a C₁- to C₅-alkoxy group, preferably a methoxy and/or ethoxy group,
n is an integer from 0 to 20, preferably 0 to 10, especially 0 to 5, more preferably 0.
m is an integer from 0 to 20, preferably 0 to 10, especially 0 to 5,
is an integer from 0 to 20, preferably 0 to 10, especially 0 to 5, more preferably 0,
p is an integer from 1 to 200, preferably 10 to 100, especially 15 to 50.
where n, m, o and p each indicate the number of structural units shown in the respective set of brackets in the organopolysiloxane and where these structural units shown in the brackets may be present either in blocks or in random arrangement in the organopolysiloxane.
where either m and/or o≥1, and/or at least one R₃ radical in the compound of formula [V] is a linear or branched alkyl, aryl, alkylaryl or arylalkyl radical having 5 to 25 carbon atoms, and
where the value of the sum total of n+m+o+p is preferably >5, further preferably >10, more preferably >15, most preferably >20.

By virtue of this preferred value of the sum total of n+m+o+p, the organopolysiloxane (also referred to as polyorganosiloxane) has a minimum molar mass and migrates to a lesser degree to the surface of shaped bodies comprising the composition of the invention. This reduces the adverse effects on the surface impression and on composite adhesion to other materials such as varnishes, foams, other thermoplastic materials and metals.

What is meant by the wording “identical or different radicals” is that, firstly, within a specific structural unit, radicals having the same symbol, for example R₃, may be the same or different. Secondly, the organopolysiloxane may also include structural units that do belong to the general structure specified in the respective set of brackets but differ from other structural units that likewise belong to this general structure with regard to the specific radicals, for example R₃.

In a further preferred embodiment, the organopolysiloxanes contain structural units of the formula [VIb] and structural units selected from at least one representative selected from the group of structural units of the formulae [VIa] and [VIc]

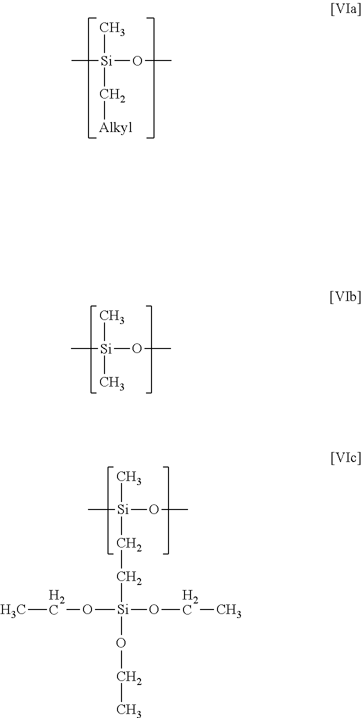

The alkyl radical in the formula [VIa] here contains 5 to 23 carbon atoms, preferably 7 to 20 carbon atoms, more preferably 10 to 18 carbon atoms. Further preferably, the carbon atom of the alkyl radical bonded to the Si—CH₂ group has two hydrogen atoms, i.e. is a further CH₂ group. Further preferably, the alkyl radical is linear.

In a further preferred embodiment, the organopolysiloxanes, aside from the end groups, consist of structural units of the formula [VIb] and structural units selected from at least one representative selected from the group of structural units of the formulae [VIa] and [VIc].

In a specific embodiment, the organopolysiloxanes, aside from the end groups, consist of structural units of the formulae [VIa] and [VIb], further preferably in a molar [VIa]/[VIb] ratio, of 0.10 to 0.70, further preferably in a molar ratio of 0.15 to 0.50, more preferably in a molar ratio of 0.25 to 0.45.

The molar ratio [VIa]/[VIc] of the structural units of the formulae [VIa] and [VIc] is preferably in the range from 0 to 10, further preferably in the range of 0 to 5, more preferably in the range from 0 to 2. In a further preferred embodiment, the molar ratio [VIa]/[VIc] is 0.

The molar ratio ([VIa]+[VIc])/[VIb] of the structural units of the formulae [VIa]. [VIb] and [VIc] is preferably in the range from 0.10 to 1.00, further preferably in the range of 0.20 to 0.50, more preferably in the range from 0.30 to 0.45.

In a further preferred embodiment, the organopolysiloxane contains the structural units of the formulae [VIa], [VIb] and [VIc]. In this preferred embodiment too, the abovementioned preferred ranges with regard to the molar ratios of the structural units are applicable.

The organopolysiloxanes of the invention can be characterized with regard to their structure by means of ¹H NMR spectroscopy in deuterated chloroform at room temperature. For organopolysiloxanes containing the structural units of the formulae [VIa], [VIb] and [VIc], this results in the following characteristic signals:
a) 0.01-0.20 ppm (3H, CH₃ bonded to Si), relative integral intensity: a
b) 0.44-0.65 ppm (CH₂ bonded to Si), relative integral intensity: b
c) 0.88 ppm (3H, terminal CH₃ in the alkyl radical), relative integral intensity: c
d) 1.16-1.42 ppm (CH₂ in aliphatic chain & CH₃ in ethoxy group), relative integral intensity: d
e) 3.81 ppm (6H, CH₂ in ethoxy group), relative integral intensity: e

The values c and e of the relative integral intensities of the 1H NMR signals c) and e) give the molar ratio of the structural units of the formulae [VIa] and [VIc] for component C-2 by the formula [VIa]/[VIc]=2c/e. In this respect, the ratio 2c/e of the relative integral intensities of the corresponding 1H NMR signals of preferred organopolysiloxanes is in the range from 0 to 10, further preferably in the range from 0 to 5, more preferably in the range from 0 to 2.

The values a, c and e of the relative integral intensities of the 1H NMR signals a), c) and e) give the molar ratio ([VIa]+[VIc])/[VIb] of the structural units of the formulae [VIa]. [VIb] and [VIc] by the formula ([VIa]+[VIc])/[VIb]=(4c+2e)/(2a−2c−e). In this respect, the ratio (4c+2e)/(2a−2c−e) of the relative integral intensities of the corresponding 1H NMR signals of preferred organopolysiloxanes is in the range from 0.10 to 1.00, further preferably in the range from 0.20 to 0.50, more preferably in the range from 0.30 to 0.45.

The end groups of the organopolysiloxanes are preferably trialkylsiloxy groups, especially the trimethylsiloxy radical: it is alternatively possible to replace one or more of these alkyl groups with hydroxy groups or alkoxy groups, such as methoxy or ethoxy radicals.

In a further preferred embodiment, component C is used in the form of an aqueous dispersion. In this embodiment, the preferred use amounts of component C in the compositions of the invention are based on the amount of organopolysiloxane introduced into the composition via the aqueous dispersion.

### Component D

Component D in the context of the present invention is at least one polymer containing carboxy and/or dicarboxylic anhydride groups and containing structural units derived from at least one olefin. The olefin polymer is preferably an alpha-olefin polymer and preferably contains structural units derived from at least one compound selected from the group consisting of ethylene. 1-propene. 1-butene, 1-isobutene, 1-pentene, 1-hexene, 1-heptene, 1-octene, 1-nonene, 1-decene, 1-undecene, 1-dodecene, 1-tridecene, 1-tetradecene, 1-octadecene and 1-nonadecene. More preferably, the alpha-olefin polymer comprises structural units derived from at least one compound selected from the group consisting of ethylene. 1-propene and 1-octene.

In a preferred embodiment, component D has a saponification value, measured to ISO 3657 (2013 version), of at least 30 mg KOH/g. Further preferably, the saponification value is 30 to 200 mg KOH/g, more preferably 40 to 120 mg KOH/g. The determination of the saponification value covers both dicarboxylic anhydride groups and carboxy groups. The stated ranges for the saponification value are applicable irrespective of whether components D contains exclusively dicarboxylic anhydride groups, exclusively carboxy groups or both the functional groups mentioned.

Carboxy groups may result from partial hydrolysis of dicarboxylic anhydride groups. They may also be introduced by copolymerization or grafting of the alpha-olefin polymer with vinyl monomers containing carboxylic groups, for example acrylic acid, methacrylic acid or similar compounds. In addition, it is possible to produce carboxy groups by controlled oxidation of the alpha-olefin polymer.

The dicarboxylic anhydride-modified alpha-olefin polymers are preferably those polymers containing structural units derived from at least one unsaturated dicarboxylic anhydride which is preferably selected from at least one representative selected from the group consisting of maleic anhydride, phthalic anhydride, fumaric anhydride, itaconic anhydride. Particular preference is given to maleic anhydride.

The anhydride-modified alpha-olefin polymer is preferably rubber-free.

Preferably, the alpha-olefin polymer comprises (component D)
Da) 75.0-99.5% by weight, preferably 90.0-99.0% by weight, more preferably 94.0-98.0% by weight, of structural units derived from at least one compound selected from the group consisting of ethylene, 1-propene, 1-butene, 1-isobutene, 1-pentene, 1-hexene, 1-heptene, 1-octene, 1-nonene, 1-decene, 1-undecene, 1-dodecene, 1-tridecene, 1-tetradecene, 1-octadecene and 1-nonadecene, and
Db) 0.5-25.0% by weight, preferably 1.0-10.0% by weight and more preferably 2.0-6.0% by weight of structural units derived from at least one unsaturated dicarboxylic anhydride.

In a preferred embodiment, the olefinic portion Da) of the alpha-olefin polymer consists of propylene and/or ethylene. Further preferably, the olefinic portion Da) of the alpha-olefin polymer consists of propylene.

The average molecular weight M_{w} of component D is preferably 3000 to 40 000 g/mol, further preferably 8000 to 32 000 g/mol, more preferably 15 000 to 25 000 g/mol. Molecular weight M_{w} is determined by means of gel permeation chromatography in ortho-dichlorobenzene at 150° C., with polystyrene calibration.

The combination of the preferred ranges for the saponification value and the average molecular weights M_{w} of component D as specified above is particularly suitable in order to optimize, in particular, the multiaxial impact resistance of molded articles produced from the compositions of the invention.

### Component E

The composition may include, as component E, one or more polymer additives and/or processing auxiliaries and/or further polymeric components, preferably selected from the group consisting of flame retardants, anti-drip agents, flame retardant synergists, smoke inhibitors, lubricants and demolding agents, nucleating agents, antistats, conductivity additives, stabilizers (for example hydrolysis, heat aging and UV stabilizers, and transesterification inhibitors), flow promoters, phase compatibilizers, polymeric blend partners other than components C and D, such as rubber-modified graft polymers or rubber-free vinyl (co)polymers, organic fillers and reinforcers, and organic dyes and pigments.

In a preferred embodiment, component E comprises a polymer other than components A. C and D that contains reactive groups capable of reacting with OH groups. The reactive groups may, for example, be carboxy, anhydride or epoxy groups. The reactive groups are preferably epoxy groups.

Further preferably, the polymer is a vinyl (co)polymer, even further preferably a rubber-free vinyl (co)polymer. The vinyl (co)polymer is preferably a methyl methacrylate copolymer or a styrene-acrylonitrile copolymer. Most preferably, a copolymer is used, obtained by polymerization of methyl methacrylate and glycidyl methacrylate, or a terpolymer obtained by polymerization of styrene, acrylonitrile and glycidyl methacrylate.

In a preferred embodiment, lubricants and mold release agents used are fatty acid esters, more preferably fatty acid esters of pentaerythritol or glycerol.

In a preferred embodiment, the stabilizer used is at least one representative selected from the group consisting of sterically hindered phenols, organic phosphites and sulfur-based co-stabilizers.

In a particularly preferred embodiment, the stabilizer used is at least one representative selected from the group consisting of octadecyl-3-(3,5-di-tert-butyl-4-hydroxyphenyl) propionate and tris(2,4-di-tert-butylphenyl)phosphite.

### Production of the Composition

Inventive components A, B, C, D and optionally E can be used to obtain a composition by physical blending. It is possible here for all components of the compositions to be mixed simultaneously, or for part-mixtures first to be produced from particular components of the composition. It is particularly advantageous to produce a part-mixture of components B and C or of portions of components B and/or C.

The compositions of the invention or the part-mixtures that form the compositions of the invention can be used to produce molding compounds having a low content by mass of free BPA.

These molding compounds can be produced, for example, by melt-compounding and melt-extruding the compositions of the invention or the part-mixtures that form the compositions of the invention at temperatures of preferably 200° C., to 350° C., more preferably at 220° C., to 330° C., even more preferably at 260° C., to 320° C., in customary apparatuses such as single-shaft extruders, corotatory or counter-rotatory twin-shaft extruders, planetary roll extruders, internal kneaders or cokneaders. The dwell time of the components in the melt is 15 seconds to 5 minutes. In the context of this invention, this process is generally referred to as compounding.

A molding compound of the invention thus means the product which is obtained when the compositions of the invention or the part-mixtures that form the compositions of the invention are melt-compounded and melt-extruded. Alternative terms are compound and molding compound.

The constituents of the composition of the invention or the part-mixtures that form the compositions of the invention may be metered in here in a known manner into the compounding unit either successively or simultaneously. This means that, for example, some of the constituents, optionally in premixed form, may be metered in, for example, via the main intake of an extruder and the remaining constituents, optionally in premixed form, may be introduced later in the compounding process via one or more side extruders.

It is preferable to meter in a part-mixture comprising the whole amount or proportions of components B and C via a side extruder into the part-mixture, already melted in an upstream part of the compounding aggregate process, of the residual, optionally likewise physically premixed components of the composition of the invention, optionally also comprising the residual proportions of components B and/or C.

In a particular embodiment of the present invention, the molding compound of the invention is produced by a process comprising the following steps:
(i) mixing component B or a portion of component B with a portion or the entirety of component C.
(ii) optionally conditioning the mixture produced in step (i) and
(iii) melt compounding the mixture obtained in step (i) or (ii) together with components A. D and optionally E, and with any residual amounts of components B and/or C if only a portion of component B and/or component C has been used in step (i).

Step (i), in a specific embodiment, is preferably performed in a container-type high-intensity mixer.

Such mixers are supplied, for example, by Mixaco Maschinenbau Dr. Herfeld GmbH & Co. KG (Neuenrade, Germany) or Zeppelin Systems GmbH (Friedrichshafen, Germany), in the latter case often under the “Henschel mixer” name.

In the context of the present invention, conditioning in step (ii) means storage of the mixture obtained in step (i). Storage can be effected at room temperature and at higher temperature. If the storage takes place at room temperature, it is effected over a period of preferably at least 6 hours, further preferably of at least 12 hours, more preferably of at least 24 hours. The storage times can be shortened by increasing the temperature.

Conditioning is found to be particularly preferable if component C used is a compound of formula [V] where m is at least 1 and where at least one instance of R₇ is a C₁- to C₅-alkoxy group, preferably a methoxy and/or ethoxy group. This is the case, for example, when component C contains structural units of formula [VIc].

In a further preferred embodiment, component C is used in the process of the invention in the form of an aqueous dispersion.

Component C, more preferably if it is used in the process of the invention in the form of an aqueous dispersion, in a further preferred embodiment, may also already be applied to the surface of the inorganic filler at the early stage of formulation thereof, for example and with preference in the course of wet grinding and/or compaction thereof, by blending. In this case, the result is thus a mixture of the whole amounts or portions of components B and C already at the early stage of formulation of the inorganic filler. In this respect, step (i) of the above-described process of the invention, in this embodiment, is part of the formulation process for the inorganic filler.

The compositions can be used to produce shaped bodies. These may be produced for example by injection molding, extrusion, and blow-molding processes. A further form of processing is the production of shaped bodies by thermoforming from previously produced sheets or films.

It is also possible to meter the components directly into the conveying extruder of an injection molding machine, to produce the composition in the conveying extruder and to process the composition directly to shaped bodies by correspondingly discharging said compound into an injection mold (compounding or reactive compounding injection molding).

The present invention thus further relates to the use of a composition according to the invention or molding compound for producing shaped bodies, and additionally also to a shaped body that is obtainable from a composition according to the invention or molding compound or that contains such a composition.

Examples of such shaped bodies are films, profiles, housing parts of any type, for example for domestic appliances such as juice presses, coffee machines, mixers: for office machinery such as monitors, flatscreens, notebooks, printers, copiers: sheets, pipes, electrical installation ducts, windows, doors and other profiles for the construction sector (internal fitout and external applications), and also electrical and electronic components such as switches, plugs and sockets, and component parts for commercial vehicles, in particular for the automotive sector. The compositions and molding compounds of the invention are also suitable for producing the following shaped bodies or molded articles: internal fitout parts for rail vehicles, ships, aircraft, buses and other motor vehicles, bodywork components for motor vehicles, housings of electrical equipment containing small transformers, housings for equipment for the processing and transmission of information, housings and facings for medical equipment, massage equipment and housings therefor, toy vehicles for children, sheetlike wall elements, housings for safety equipment, thermally insulated transport containers, molded parts for sanitation and bath equipment, protective grilles for ventilation openings and housings for garden equipment.

Further embodiments of the present invention are listed below.
1. A composition comprising
A) at least one polycarbonate and/or polyester carbonate.
B) at least one inorganic filler.
C) at least one compound or a mixture of two or more different compounds of the general structural formula [V]

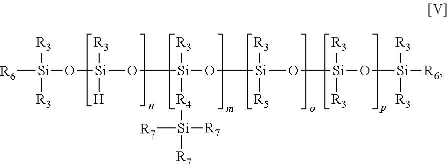

in which
R₃ represents identical or different radicals selected from the group consisting of linear or branched alkyl, aryl, alkylaryl or arylalkyl radicals having 1 to 25 carbon atoms and haloalkyl, haloaryl, haloalkylaryl or haloarylalkyl radicals having 1 to 25 carbon atoms.
R₄ represents identical or different alkylene radicals which have 1 to 20 carbon atoms and may optionally contain ether, ester, urethane or amide groups.
R₅ represents identical or different oxyalkylene radicals of the general formula [Va]

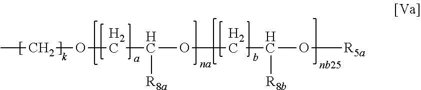

where, in formula [Va].
R₅ₐ, R₈ₐ and R_{8b} independently represent identical or different, optionally branched alkyl or aryl radicals optionally bearing heteroatom substituents, or hydrogen.
k is an integer from 2 to 11.
a, b are identical or different integers between 1 and 4 and
na and nb are identical or different integers between 0 and 50.
where k, na and nb each indicate the number of structural units shown in the respective set of brackets in the oxyalkylene radical of the general formula [Va] and where these structural units shown in the brackets may be present either in blocks or in random arrangement in the oxyalkylene radicals of the general formula [Va].
R₆ represents identical or different radicals selected from the group consisting of R₃, —R₄Si(R₇)₃, R₅ and H.

R₇ represents identical or different alkyl, alkoxy, aryl or aryloxy radicals having 1 to 20 carbon atoms, with the proviso that at least one instance of R₇ is a C1- to C5-alkoxy group, and
n is an integer from 0 to 20,
m is an integer from 0 to 20,
is an integer from 0 to 20 and
p is an integer from 1 to 200.
where n, m, o and p each indicate the number of structural units shown in the respective set of brackets in the organopolysiloxane and where these structural units shown in the brackets may be present either in blocks or in random arrangement in the organopolysiloxane, where either m and/or o≥1, and/or at least one R₃ radical in the compound of formula [V] is a linear or branched alkyl, aryl, alkylaryl or arylalkyl radical having 5 to 25 carbon atoms and where the value of the sum total of n+m+0+p is >5.
D) at least one polymer containing carboxy groups and/or dicarboxylic anhydride groups and containing structural units derived from at least one olefin.
2. The composition according to embodiment 1, characterized in that component A is a polycarbonate and/or polyester carbonate, each containing structural units derived from bisphenol A.
3. The composition according to either of embodiments 1 and 2, characterized in that component C is used in an amount of 0.2 to 5 parts by weight, based on a total of 100 parts by weight of components B and C.
4. The composition according to either of embodiments 1 and 2, characterized in that component C is used in an amount of 0.7 to 1.5 parts by weight, based on a total of 100 parts by weight of components B and C.
5. The composition according to any of the preceding embodiments, characterized in that component D is used in an amount of 1 to 15 parts by weight, based on a total of 100 parts by weight of components B and D.
6. The composition according to any of the preceding embodiments, characterized in that component D is used in an amount of 3 to 7 parts by weight, based on a total of 100 parts by weight of components B and D.
7. The composition according to any of the preceding embodiments, characterized in that component B is selected from the group consisting of quartz compounds, talc, wollastonite, kaolin, CaCO₃, titanium dioxide and other inorganic pigments, Al(OH)₃, AlO(OH), Mg(OH)₂, micas and glass fibers.
8. The composition according to any of the preceding embodiments, characterized in that component B is talc.
9. The composition according to any of the preceding embodiments, characterized in that components B and C, each in part or in full, are used in the form of an inorganic filler of component B that has been sized with component C.
10. The composition according to any of the preceding embodiments, wherein the value of the sum total of n+m+0+p is >20.
11. The composition according to any of the preceding embodiments, characterized in that component C contains structural units of the formula [VIb] and structural units selected from at least one representative selected from the group of structural units of the formulae [VIa] and [VIc]

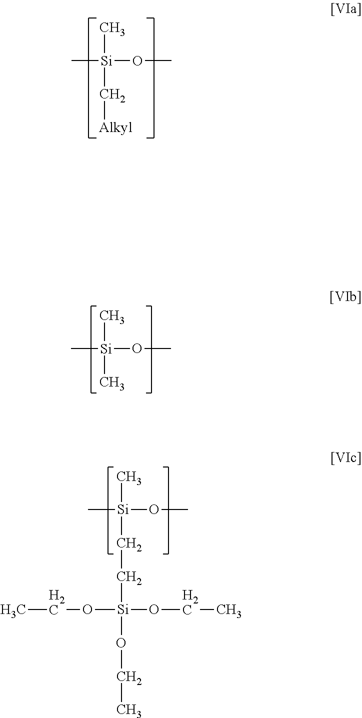

where the alkyl radical in the structure [VIa] contains 5 to 23 carbon atoms.
12. The composition according to embodiment 11, wherein the organopolysiloxane, apart from the end groups, consists of structural units of the formulae [VIa] and [VIb] in a molar ratio [VIa]/[VIb] of 0.10 to 0.70.
13. The composition according to embodiment 11, wherein the organopolysiloxane, apart from the end groups, consists of structural units of the formulae [VIa] and [VIb] in a molar ratio [VIa]/[VIb] of 0.25 to 0.45.
14. The composition according to embodiment 11, wherein the organopolysiloxane contains the structural units of the formulae [VIa], [VIb] and [VIc].
15. The composition according to embodiment 11 or 14, wherein the molar ratio ([VIa]+[VIc])/[VIb] of the structural units of the formulae [VIa], [VIb] and [VIc] is in the range from 0.10 to 1.00.
16. The composition according to embodiment 11, wherein the organopolysiloxane, apart from the end groups, consists of structural units of the formulae [VIa], [VIb] and [VIc] in a molar ratio ([VIa]+[VIc])/[VIb] of 0.30 to 0.45.
17. The composition according to any of the preceding embodiments, characterized in that component D has a saponification value, measured to ISO 3657 (2013 version), of at least 30 mg KOH/g.
18. The composition according to any of the preceding embodiments, characterized in that component D has a saponification value, measured to ISO 3657 (2013 version), of 30 to 200 mg KOH/g.
19. The composition according to any of the preceding embodiments, wherein component D comprises
   Da) 90.0-99.0% by weight of structural units derived from at least one compound selected from the group consisting of ethylene, 1-propene, 1-butene, 1-isobutene, 1-pentene, 1-hexene, 1-heptene, 1-octene, 1-nonene, 1-decene, 1-undecene, 1-dodecene, 1-tridecene, 1-tetradecene, 1-octadecene and 1-nonadecene, and
   Db) 1.0-10.0% by weight of structural units derived from at least one unsaturated dicarboxylic anhydride.
20. The composition according to embodiment 19, wherein the olefinic portion Da of component D consists of propylene and/or ethylene.
21. The composition according to any of the preceding embodiments, wherein the average molecular weight M_{w} of component D is 3000 to 40 000 g/mol.
22. The composition according to any of the preceding embodiments, containing
   25% to 95% by weight of component A.
   1% to 50% by weight of component B.
   0.002% to 2.5% by weight of component C
   and 0.01% to 7.5% by weight of component D.
23. The composition according to any of the preceding embodiments, containing
   40% to 75% by weight of component A,
   5% to 30% by weight of component B, 0.035% to 0.45% by weight of component C
   and 0.15% to 2.1% by weight of component D.
24. The composition according to any of the preceding embodiments, further comprising, as component E, a nonpolymeric Brønsted-acidic compound and/or a polymer containing epoxy groups other than components A, C and D.
25. The composition according to any of the preceding embodiments, consisting of components A, B, C, D and E.
26. A process for producing a thermoplastic molding compound obtained from a composition comprising the following components:
A) at least one polymer selected from the group consisting of polycarbonate and/or polyester carbonate.
B) at least one inorganic filler.
C) at least one organopolysiloxane containing at least one structural unit of the general formula

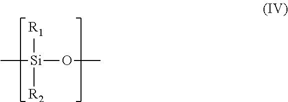

in which R₁ and R₂ are independently hydrogen or hydrocarbyl radicals that may each be substituted or unsubstituted and optionally interrupted by heteroatoms such as O, N or Si, and may be linear, branched or cyclic,
where the organopolysiloxane contains at least one structural unit of the general formula (IV) in which at least one of the R₁ or R₂ radicals is different than both hydrogen and methyl, and where the organopolysiloxane is free of siloxane structural units in which two hydrogen atoms are bonded to the same silicon atom,
D) at least one polymer containing carboxy and/or dicarboxylic anhydride groups and containing structural units derived from at least one olefin.
comprising the following steps:
   (i) mixing component B or a portion of component B with a portion or the entirety of component C.
   (ii) preferably conditioning the mixture produced in step (i) and
   (iii) melt compounding the mixture obtained in step (i) or (ii) together with components A, D, optionally one or more polymer additives, process auxiliaries and/or further polymeric components as component E, and with the residual amounts of components B and/or C if only portions of components B and/or C have been used in step (i).
27. The process according to embodiment 26, wherein process step (ii) is conducted and, in this process step, the organopolysiloxane of component C is reacted partly or fully with the inorganic filler of component B, and the organopolysiloxane of component C is partly or fully covalently bonded to the surface of the inorganic filler of component B.
28. The process according to embodiment 26 or 27, wherein, in step (i), component C is used in the form of an aqueous dispersion.
29. The process according to any of embodiments 26 to 28, wherein component C or a portion of component C, in the formulation of the inorganic filler of component B, is blended with said inorganic filler of component B or a portion thereof.
30. The process according to embodiment 29, wherein component C or a portion of component C, in the wet grinding and/or compaction of the inorganic filler of component B, is blended with said inorganic filler of component B or a portion thereof.
31. The process according to any of embodiments 26 to 29, wherein the component C used is a compound of formula [V].
32. A thermoplastic molding compound produced in a process according to any of embodiments 26 to 31 and/or obtained from a composition according to any of embodiments 1 to 25.
33. The use of a combination of
   at least one organopolysiloxane containing at least one structural unit of the general formula

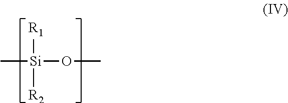

in which R₁ and R₂ are independently hydrogen or hydrocarbyl radicals that may each be substituted or unsubstituted and optionally interrupted by heteroatoms such as O, N or Si, and may be linear, branched or cyclic.
where the organopolysiloxane contains at least one structural unit of the general formula (IV) in which at least one of the R₁ or R₂ radicals is different than both hydrogen and methyl, and where the organopolysiloxane is free of siloxane structural units in which two hydrogen atoms are bonded to the same silicon atom,
and at least one polymer containing carboxy and/or dicarboxylic anhydride groups and containing structural units derived from at least one olefin for reduction of the free bisphenol A content of molding compounds produced by melt compounding and/or shaped bodies produced by thermal shaping, each comprising polycarbonate and/or polyester carbonate and inorganic filler, where the polycarbonate and/or polyester carbonate in each case contains structural units derived from bisphenol A.
34. The use according to embodiment 33, wherein the polymer containing carboxy and/or dicarboxylic anhydride groups and containing structural units derived from at least one olefin is an anhydride-modified alpha-olefin polymer having a saponification value, measured to ISO 3657 (2013 version), of at least 30 mg KOH/g.
35. The use according to either of embodiments 33 and 34, wherein the component C used is a compound of formula [V].
36. A shaped body comprising a composition according to any of embodiments 1 to 25 or a thermoplastic molding compound according to embodiment 32.

### EXAMPLES

### Component A-1:

Linear polycarbonate based on bisphenol A, produced by the interfacial polymerization method, having a weight-average molecular weight M_{w} of 25 000 g/mol (determined at room temperature by GPC in methylene chloride against a BPA-PC standard).

### Component A-2:

Linear polycarbonate based on bisphenol A, produced by the interfacial polymerization method, having a weight-average molecular weight M_{w} of 28 000 g/mol (determined at room temperature by GPC in methylene chloride against a BPA-PC standard).

### Component A-3:

Linear polycarbonate based on bisphenol A, produced by the interfacial polymerization method, having a weight-average molecular weight M_{w} of 32 000 g/mol (determined at room temperature by GPC in methylene chloride against a BPA-PC standard).

### Component B-1:

Luzenac™ A7C (Imerys Performance Additives, Toulouse, France): Compacted talc having an iron oxide content of 0.2% by weight, an aluminum oxide content of 0.3% by weight and a calcium oxide content of 0.4% by weight, d₅₀ measured by sedimentation analysis to ISO 13317-3 (2001-03 version) is 2.2 μm; d₉₅ measured by sedimentation analysis to ISO 13317-3 (2001-03 version) is 7 μm. This talc does not contain any sizing as per component C.

### Component B-2:

Luzenac™ R7C (Imerys Performance Additives, Toulouse, France): Compacted talc having an iron oxide content of 0.2% by weight, an aluminum oxide content of 0.3% by weight and a calcium oxide content of 0.4% by weight, d₅₀ measured by sedimentation analysis to ISO 13317-3 (2001-03 version) is 2.2 μm; d₉₅ measured by sedimentation analysis to ISO 13317-3 (2001-03 version) is 7 μm. Component B-2 contains an organopolysiloxane corresponding to component C, which has been applied to the surface of the talc in the formulation thereof by blending of talc and organopolysiloxane. The organopolysiloxane of component C is present in component B-2 in a concentration of 1.0% by weight. In structural terms, the organopolysiloxane present in component B-2, by 1H NMR spectroscopy, corresponds to component C-1. For structural characterization and for quantification of the organopolysiloxane in component B-2, component B-2 was subjected to ASE extraction in chloroform. The ASE extract was separated, the chloroform was distilled off, and the distillation residue was dissolved in deuterated chloroform with an accurately weighed amount of dimethyl terephthalate as quantitative internal standard and analysed by 1H NMR spectroscopy. The position and relative intensity of all the 1H NMR signals observed corresponded to the corresponding values that were observed for component C-1. The ratio of the integrated intensity of the 1H NMR signals originating from the organopolysiloxane to the integrated intensity of the 1H NMR signals of the dimethyl terephthalate standard was used to arithmetically ascertain the aforementioned content of component C in component B-2, assuming that component C in component B-2 structurally corresponds to compound C-1.

### Component B-3:

Jetfine™ 3CA (Imerys Performance Additives. Toulouse, France): Compacted talc having an iron oxide content of 0.2% by weight, an aluminum oxide content of 0.4% by weight and a calcium oxide content of 0.3% by weight, d₅₀ measured by sedimentation analysis to ISO 13317-3 (2001-03 version) is 1.1 μm; dos measured by sedimentation analysis to ISO 13317-3 (2001-03 version) is 3.5 μm. This talc does not contain any sizing as per component C.

### Component C-1

Tegopren™ 6875 (Evonik Nutrition & Care GmbH. Essen, Germany):
Organopolysiloxane containing structural units of formulae [VIa] and [VIb] in the polymer backbone.

Results of the 1H NMR spectroscopy characterization (in deuterated chloroform at room temperature) of components C-1:
a) 0.01-0.15 ppm (3H, CH₃ bonded to Si), relative integral intensity: a=20.82
b) 0.50 ppm (2H, CH₂ bonded to Si), relative integral intensity: b=2.00
c) 0.88 ppm (3H, terminal CH₃ in the alkyl radical), relative integral intensity: c=3.41
d) 1.26 ppm (2H, CH₂ in aliphatic chain), relative integral intensity: d=29.80

The values a and c of the relative integral intensities of the 1H NMR signals a) and c) give a molar ratio of the structural units of the formulae [VIa] and [VIb] of 0.39 for component C-1 by the formula

[VIa]/[VIb]=2c/(a−c).

It is apparent from the ratio of the ¹H NMR signals c) and d) for component C-1 that the alkyl radical in the structural unit of formula [VIa] is formed on average from 14 carbon atoms.

### Component C-2

Tegopren™ 6879 (Evonik Nutrition & Care GmbH. Essen, Germany):
Organopolysiloxane containing structural units of formulae [VIa], [VIb] and [VIc] in the polymer backbone.

Results of the 1H NMR spectroscopy characterization (in deuterated chloroform at room temperature) of components C-2:
a) 0.01-0.20 ppm (3H, CH₃ bonded to Si), relative integral intensity: a=47.35
b) 0.44-0.65 ppm (CH₂ bonded to Si), relative integral intensity: b=6.02
c) 0.88 ppm (3H, terminal CH₃ in the alkyl radical), relative integral intensity: c=3.93
d) 1.16-1.42 ppm (CH₂ in aliphatic chain & CH₃ in ethoxy group), relative integral intensity: d=43.25
e) 3.81 ppm (6H, CH₂ in ethoxy group), relative integral intensity: e=6.00

The values a and e of the relative integral intensities of the 1H NMR signals a) and e) give a molar ratio of the structural units of the formulae [VIa] and [VIc] of 1.31 for component C-2 by the formula

$$[ VIa ] / [ VIc ] = 2 c / e .$$

The values a, c and e of the relative integral intensities of the ¹H NMR signals a), c) and e) give a molar ratio ([VIa]+[VIc])/[VIb] of the structural units of the formulae [VIa], [VIb] and [VIc] of 0.34 for component C-2 by the formula ([VIa]+[VIc])/[VIb]=(4c+2e)/(2a−2c−e).

### Component C-3

DOWSIL™ FCA-107 Flake (The Dow Chemical Company, Midland MI (United States)) Hydroxy-terminated phenylsilsesquioxane

### Component D

A-C™ 907P (Honeywell Corp., Morristown NJ, USA): Maleic anhydride-grafted polypropylene (CAS No. 25722-45-6) having a saponification value, measured to ISO 3657 (2013 version) of 87 mg KOH/g and a melt viscosity measured at 190° C., with a Brookfield rotary viscometer of 350 cP. The weight-average molecular weight M_{w}, determined by gel permeation chromatography in ortho-dichlorobenzene at 150° C., with polystyrene calibration, is 20 700 g/mol.

### Component E-1:

Fabutit™ 289: ortho-phosphoric acid absorbed on silica gel (Chemische Fabrik Budenheim KG, Budenheim, Germany).

### Component E-2:

Fine-Blend™ SAG 008 (Fine-Blend Polymer (Shanghai) Co., LTD, Shanghai, China): Random terpolymer produced by free-radical polymerization of glycidyl methacrylate, styrene and acrylonitrile with a glycidyl methacrylate content of 8% by weight. The epoxy content of component E-2 measured to ASTM D 1652-11 in dichloromethane is 2.4% by weight.

### Component E-3:

Mixture of (i) a styrene-acrylonitrile copolymer having an acrylonitrile content of 23% by weight and having a weight average molecular weight M_{w} of 100 000 Da, measured by GPC at room temperature in tetrahydrofuran with polystyrene as standard. (ii) an ABS polymer produced by bulk polymerization with an A:B:S weight ratio of 24%:10%:66% and with a gel content, measured as the fraction insoluble in acetone at room temperature, of 19% by weight, where the acetone-soluble sol content of the ABS polymer produced by bulk polymerization has a weight-average molecular weight M_{w} of 125 000 Da, measured by GPC at room temperature in tetrahydrofuran with polystyrene as standard, and (iii) a graft polymer prepared by emulsion polymerization and having a core-shell structure, consisting of 75% by weight of a silicone-acrylate composite rubber as core and 25% by weight of a polymethylmethacrylate shell, and having a gel content, measured as the fraction insoluble in acetone at room temperature, of 90% by weight. As a mixture of the three constituents (i), (ii) and (iii), component E-3 has a gel content, measured as the fraction insoluble in acetone at room temperature, of 23% by weight. This gel content of component E-3 originates to an extent of 22% by weight from the bulk ABS component (ii) and to an extent of 78% by weight from the graft polymer having core-shell structure (iii). The proportion of component (i) is 53% by weight, based on component E-3.

### Component E-4:

Irganox™ B900 (BASF AG. Ludwigshafen, Germany): Stabilizer
(mixture of 80% Irgafos™ 168 (tris(2,4-di-tert-butylphenyl)phosphite) and 20% Irganox™ 1076 (2,6-di-tert-butyl-4-(octadecaneoxycarbonylethyl)phenol) (manufacturer: BASF AG))

### Component E-5:

Pentaerythritol tetrastearate (demolding agent)

### Component E-6:

Black Pearls™ 800 (Cabot Corp., Belgium): carbon black pigment

### Production of the Compositions

Components A to E of the respective compositions were processed to a molding compound in a single compounding step according to the proportions by weight shown in tables 1 to 4 in a ZSK26 MC18 twin-shaft extruder (Coperion GmbH. Stuttgart, Germany) (in the case of the examples in tables 1, 2 and 4) or in a Process 11 twin-shaft laboratory extruder (Thermo Fisher Scientific Inc. Waltham, MA, USA) (in the case of the examples in table 3). A melting temperature of 290° C., was used in the examples in tables 1, 3 and 4, and a melting temperature of 280° C., in the examples in table 2. In all cases, a degassing vacuum of 70 mbar (absolute) was applied in an extruder zone close to the exit nozzle of the extruder.

In the case of the examples in tables 1, 2 and 4, all components of the composition, except for the talc, were metered together into the extruder inlet via the main intake and melted and dispersed in one another by introduction of thermal and mechanical energy. The talc was metered here via a side extruder into the melt mixture of the remaining components, i.e. into an extruder zone on the other side of the melting zone relative to the main intake. The dwell time of the components in the melt in this process of the examples according to tables 1 and 2 was about 30 seconds.

In the examples in table 3, premixes of the total amounts of components B and C were first produced in the ratio of amounts correspondingly stated in table 3. The pulverulent mixtures comprising components B and C were produced by means of a laboratory container mixer of the Mixaco LAB CM 1.5 type (MIXACO Dr. Herfeld GmbH & Co KG, Neuenrade, Germany). For this purpose, the talc of component B formed an initial charge in the mixing vessel that about half-filled the mixing vessel, and the liquid organopolysiloxane of component C, with the mixing tool running, was then injected via a bore with a sunk cannula in the lid of mixing vessel by means of a syringe into the atmosphere of talc powder thrown up by the mixing tool over a period of about 30 seconds, and hence distributed largely homogeneously over the surface thereof. The preliminary mixtures of components B and C thus produced were either used immediately in the compounding operation or equilibrated beforehand in the laboratory atmosphere for 24 h (conditioning). In the production of the molding compounds from the compositions according to table 3, the preliminary mixtures of components B and C produced in this way were premixed with components A that had been used in the form of granules ground to powder, and optionally D, in the ratios of amounts stated in table 3, and the composition produced in this way was fed to the compounding process via the main intake of the laboratory extruder. The dwell time of the components in the melt in this process of the examples according to table 3 was about 90 seconds.

### Production of Shaped Bodies and Testing

The compositions were used to produce shaped bodies of dimensions 60 mm×40 mm×2 mm at melt temperatures of 280° C., and a mold temperature of 80° C., on an Arburg 270 E injection molding machine at an injection speed of 40 mm/s.

The free bisphenol A content ([BPA] for short) was determined by dissolving the samples of the pellet materials produced and of the shaped bodies produced from the pellets in dichloromethane and reprecipitating with acetone. The precipitated polymer fraction was separated by filtration and the filtrate was analyzed by high-pressure liquid chromatography with a UV detector (HPLC-UV) using an external standard. The column material used was a C18 phase, and the eluent used was water and methanol in a gradient.

TABLE 1
Compositions and properties thereof

| Components | | | | | | | |
|---|---|---|---|---|---|---|---|
| [pts. by wt.] | V1 | V2 | V3 | V4 | 5 | 6 | 7 |
| A-1 | 80 | 80 | 80 | 80 | 80 | 80 | 80 |
| B-1 | 20 | 20 | | 20 | | | |
| B-2 | | | 20 | | 20 | 20 | 20 |
| D | | 1 | | | 1 | 1 | 1 |
| E-1 | | | | 0.2 | | 0.2 | |
| E-2 | | | | | | | 0.2 |
| Proportion by mass | 0 | 0 | 0.2 | 0 | 0.2 | 0.2 | 0.2 |
| of components C in | | | | | | | |
| the composition | | | | | | | |
| present as sizing | | | | | | | |
| in component B-2 | | | | | | | |
| [% by wt.] | | | | | | | |
| Properties | | | | | | | |
| [BPA]ₚₑₗₗₑₜₛ [ppm] | 266 | 288 | 102 | 972 | 11 | 9 | 10 |

The data in table 1 show that the molding compounds of the invention that have been obtained by melt compounding from the compositions of the invention comprising components C and D (examples 5, 6 and 7, C as sizing on the surface of the talc) have a very small proportion of free bisphenol A in the pellets as desired. In comparative example V1 comprising talc without sizing, a much higher free bisphenol A content is obtained. By addition of component D alone, the proportion of free bisphenol A is actually increased in a disadvantageous manner (V2). If only a Brønsted acid is added (V4), as described for stabilization against molecular weight degradation in the prior art, the results are particularly poor with regard to the aims being pursued in the context of the present invention, i.e. the BPA contents are at their highest. If a talc with sizing is used (V3, i.e. component C is present on the surface of the talc), the proportions of free bisphenol A in the pellets are much lower than for the other working examples V1, V2 and V4, but still at a very low level.

TABLE 2
Compositions and properties thereof

| Components [pts. by wt.] | V8 | V9 | 10 |
|---|---|---|---|
| A-2 | 49 | 49 | 49 |
| B-1 | 20 | 20 | — |
| B-2 | — | — | 20 |
| D | — | 1 | 1 |
| E-1 | 0.2 | 0.2 | 0.2 |
| E-3 | 30 | 30 | 30 |
| E-4 | 0.1 | 0.1 | 0.1 |
| E-5 | 0.7 | 0.7 | 0.7 |
| E-6 | 0.4 | 0.4 | 0.4 |
| Proportion by mass of components C in the | 0 | 0 | 0.2 |
| composition present as sizing in component B-2 | | | |
| [% by wt.] | | | |
| Properties | | | |
| [BPA]ₚₑₗₗₑₜₛ [ppm] | 20 | 14 | 4 |
| [BPA]_{shaped body}[ppm] | 31 | 19 | 10 |

The data in table 2 show that a distinctly reduced proportion of free bisphenol A in the pellets is also achieved compared to comparable compositions without component C (V8 and V9) in molding compounds produced by melt compounding from compositions comprising polymeric blend partners by the use of the inventive combination of component B-2 (comprising components C) and D according to example 10. The addition of component D does lead to a reduction in the bisphenol A content, but the additional use of component D leads to considerably better avoidance of free bisphenol A. This is also shown in the specimens produced from the pellets.

TABLE 3
Compositions and properties thereof

| Components [pts. by wt.] | V11 | V12 | 13 | 14 | 15 |
|---|---|---|---|---|---|
| A-3 | 80 | 80 | 80 | 80 | 80 |
| B-3 | 20 | 20 | 20 | 20 | 20 |
| C-1 | — | — | 0.2 | — | — |
| C-2 | — | — | — | 0.2 | 0.2 |
| D | — | 1 | 1 | 1 | 1 |
| Talc sizing method | | | | | |
| Conditioning of the preliminary | no | no | no | no | yes |
| mixture of components B-3 and | | | | | |
| C-1/C-2 for 24 h | | | | | |
| Properties | | | | | |
| [BPA]ₚₑₗₗₑₜₛ [ppm] | 533 | 234 | 71 | 50 | 18 |

The data from table 3 show that a distinct reduction in the proportion of free bisphenol A can also be achieved when the molding compounds in the process of the invention are produced with a preliminary mixture of components B and C in process step (i). At the same time, the use of component C-2 (example 14) still shows advantages over the use of component C-1 (example 13). In addition, it is advantageous to condition the preliminary mixture of components B and C prior to compounding with the other components (example 15).

TABLE 4
Compositions and properties thereof

| Components [pts. by wt.] | V16 | 17 | V18 |
|---|---|---|---|
| A-3 | 79 | 79 | 79 |
| B-3 | 20 | 20 | 20 |
| C-2 | — | 0.26 | — |
| C-3 | — | — | 0.26 |
| D | 1 | 1 | 1 |
| Properties | | | |
| [BPA]ₚₑₗₗₑₜₛ [ppm] | 262 | 36 | 263 |

The data from table 4 show that a distinct reduction in the proportion of free bisphenol A can be achieved only when the component C used is an organopolysiloxane of the invention. If, instead, the component C used is a phenylsilsesquioxane described in the prior art, the inventive effect is absent.

1. A composition comprising
A) at least one polycarbonate and/or polyester carbonate,
B) at least one inorganic filler,
C) at least one compound or a mixture of two or more different compounds of the general structural formula [V] 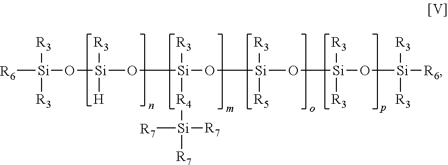
in which
R₃ represents identical or different radicals selected from the group consisting of linear or branched alkyl, aryl, alkylaryl or arylalkyl radicals having 1 to 25 carbon atoms and haloalkyl, haloaryl, haloalkylaryl or haloarylalkyl radicals having 1 to 25 carbon atoms,
R₄ represents identical or different alkylene radicals which have 1 to 20 carbon atoms and may optionally contain ether, ester, urethane or amide groups,
R₅ represents identical or different oxyalkylene radicals of the general formula [Va] 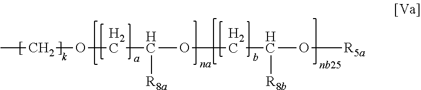
where, in formula [Va],
R₅ₐ, R₈ₐ and R_{8b} independently represent identical or different, optionally branched alkyl or aryl radicals optionally bearing heteroatom substituents, or hydrogen,
k is an integer from 2 to 11,
a, b are identical or different integers between 1 and 4 and
na and nb are identical or different integers between 0 and 50,
where k, na and nb each indicate the number of structural units shown in the respective set of brackets in the oxyalkylene radical of the general formula [Va] and where these structural units shown in the brackets may be present either in blocks or in random arrangement in the oxyalkylene radicals of the general formula [Va],
R₆ represents identical or different radicals selected from the group consisting of R₃, —R₄Si(R₇)₃, R₅ and H,
R₇ represents identical or different alkyl, alkoxy, aryl or aryloxy radicals having 1 to 20 carbon atoms, with the proviso that at least one instance of R₇ is a C1- to C5-alkoxy group, and
n is an integer from 0 to 20,
m is an integer from 0 to 20,
o is an integer from 0 to 20 and
p is an integer from 1 to 200,
where n, m, o and p each indicate the number of structural units shown in the respective set of brackets in the organopolysiloxane and where these structural units shown in the brackets may be present either in blocks or in random arrangement in the organopolysiloxane,
where either m and/or o≥1, and/or at least one R₃ radical in the compound of formula [V] is a linear or branched alkyl, aryl, alkylaryl or arylalkyl radical having 5 to 25 carbon atoms
and where the value of the sum total of n+m+0+p is >5,
D) at least one polymer containing carboxy groups and/or dicarboxylic anhydride groups and containing structural units derived from at least one olefin.

2. The composition as claimed in claim 1, characterized in that component A is a polycarbonate and/or polyester carbonate, each containing structural units derived from bisphenol A.

3. The composition as claimed in claim 1, characterized in that component C is used in an amount of 0.2 to 5 parts by weight, based on a total of 100 parts by weight of components B and C.

4. The composition as claimed in claim 1, characterized in that component D is used in an amount of 1 to 15 parts by weight, based on a total of 100 parts by weight of components B and D.

5. The composition as claimed in claim 1, characterized in that component B is talc.

6. The composition as claimed in claim 1, characterized in that components B and C are used in the form of an inorganic filler of component B that has been sized with component C.

7. The composition as claimed in claim 1, characterized in that component C contains structural units of the formula [VIb] and structural units selected from at least one representative selected from the group of structural units of the formulae [VIa] and [VIc] 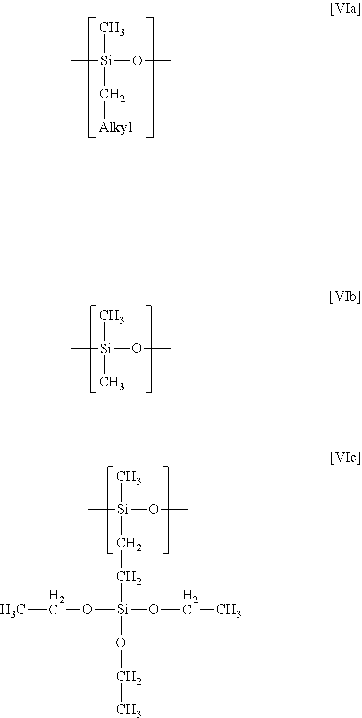
where the alkyl radical in the formula [VIa] contains 5 to 23 carbon atoms.

8. The composition as claimed in claim 7, characterized in that the molar ratio ([VIa]+[VIc])/[VIb] of the structural units of the formulae [VIa], [VIb] and [VIc] is in the range from 0.10 to 1.00.

9. The composition as claimed in claim 1, characterized in that component D has a saponification value, measured to ISO 3657 in the 2013 version, of at least 30 mg KOH/g.

10. The composition as claimed in claim 1, characterized in that component D comprises
Da) 90.0-99.0% by weight of structural units derived from at least one compound selected from the group consisting of ethylene, 1-propene, 1-butene, 1-isobutene, 1-pentene, 1-hexene, 1-heptene, 1-octene, 1-nonene, 1-decene, 1-undecene, 1-dodecene, 1-tridecene, 1-tetradecene, 1-octadecene and 1-nonadecene, and
Db) 1.0-10.0% by weight of structural units derived from at least one unsaturated dicarboxylic anhydride.

11. The composition as claimed in claim 1, containing
20% to 95% by weight of component A,
1% to 50% by weight of component B,
0.002% to 2.5% by weight of component C
and 0.01% to 7.5% by weight of component D.

12-15. (canceled)
